(19) United States
(12) Patent Application Publication
(10) Pub. No.: US 2016/0157465 A1
(43) Pub. Date: Jun. 9, 2016

(54) ANTLER SHEDDING APPARATUS

(71) Applicant: Brett Fulton, North Huntingdon, PA (US)

(72) Inventor: Brett Fulton, North Huntingdon, PA (US)

(21) Appl. No.: 14/812,181

(22) Filed: Jul. 29, 2015

Related U.S. Application Data
(60) Provisional application No. 62/004,452, filed on May 29, 2014.

(51) Int. Cl. A01K 17/00; A01K 5/01

(52) U.S. Cl. CPC A01K 17/00; A01K 5/01

(57) ABSTRACT

An antler shedding apparatus is provided. The antler shedding apparatus includes a base frame, a feed tray and a plurality of flexible uprights. The base frame supports the feed tray in an upright elevated position. The feed tray includes a feeding portion. Feed is retained within the feeding portion. The plurality of flexible uprights are secured to the antler shedding apparatus and surround the feeding portion. The feed attracts a deer to the antler shedding apparatus. When the deer's head enters through the flexible uprights, the antlers 68 may be removed from pedicle without harming the deer.

### CROSS-REFERENCE TO RELATED APPLICATION

This application claims the benefit of priority of U.S. provisional application No. 62/004,452, filed May 29, 2014, the contents of which are herein incorporated by reference.

### BACKGROUND OF THE INVENTION

The present invention relates to antler shedding and, more particularly, to an antler shedding apparatus with a built in feeder.

Antlers are extensions of the skull grown by members of the deer facility. They are true bone structures that usually grow in symmetrical pairs. For many temperate zone species, antlers are shed and regrown each year. Gathering shed antlers or “sheds” attracts dedicated practitioners who refer to it colloquially as shed hunting, or bone picking. In the United States, the middle of December to the middle of February is considered shed hunting season, when deer, elk, and moose begin to shed. Currently, finding shed antlers requires one to search for them on the forest floor, which may be difficult. Certain antler trapping devices use rubber cords, rigid rods, and fencing posts. However, deer may prematurely entangle their antlers within the cords, which may uncomfortably remove the antlers or strain the deer's neck.

As can be seen, there is a need for an improved apparatus for removing and collecting deer antlers without harming the deer.

### SUMMARY OF THE INVENTION

In one aspect of the present invention, an antler shedding apparatus comprises: a base frame; a feed tray supported by the base frame and comprising a feeding portion operable to retain a feed; and a plurality flexible uprights surrounding the feeding portion, wherein each of the plurality of flexible uprights comprises a spring biasing a post in a vertical position.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a side view of an embodiment of the present invention;

FIG. 3 is a top view of an embodiment of the present invention;

FIG. 4 is a perspective detail view of an embodiment of the present invention;

FIG. 5 is a perspective detail view of an embodiment of the present invention without a cover plate;

FIG. 6 is a section detail view of the present invention along line 6-6 in FIG. 3;

FIG. 7 is a section detail view of the present invention along line 7-7 in FIG. 1;

FIG. 8 is a section detail view of the present invention along line 8-8 in FIG. 3;

FIG. 9 is a section detail view of the present invention along line 9-9 in FIG. 2;

FIG. 10 is a detail side view of an alternate embodiment of the present invention; and

FIG. 11 is a detail side view of an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a wildlife feeder that aids deer in the antler shedding process. The feeder of the present invention allows a whitetail buck to push the spring loaded posts with his antlers to get the food and allow him to remove his head without too much resistance. If the antlers are ready to fall, the resistance of the posts causes the antlers to shed. The present invention allows for feeding and removal of antlers without entangling or harming the deer.

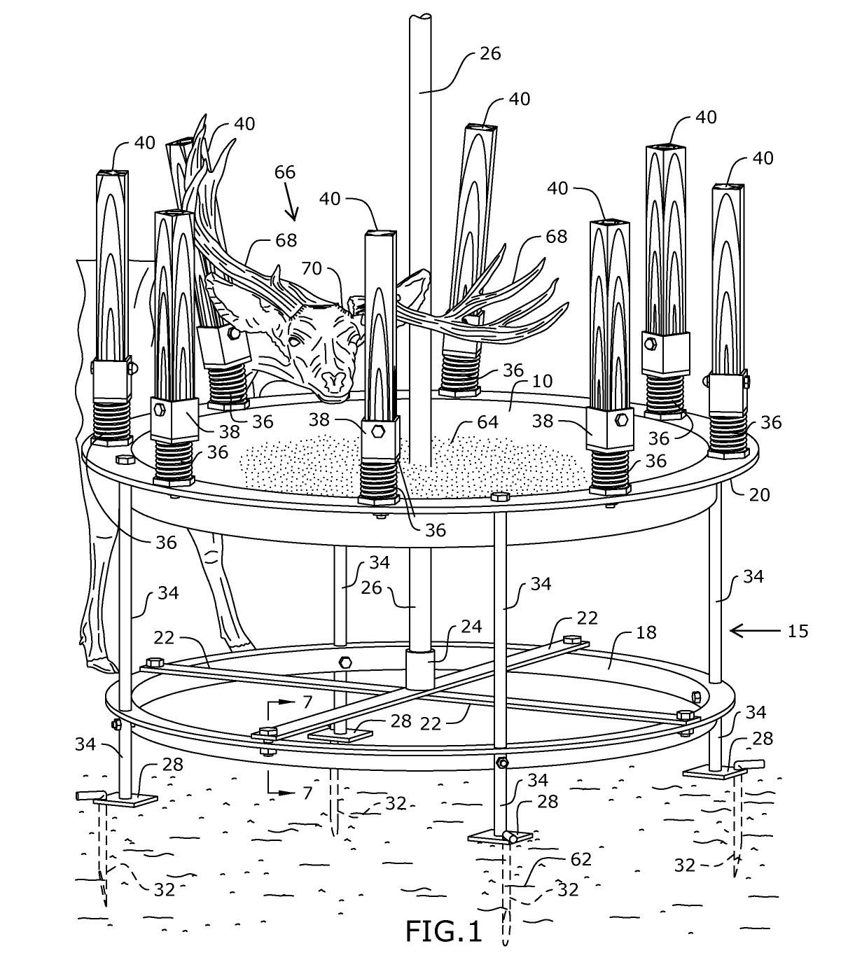

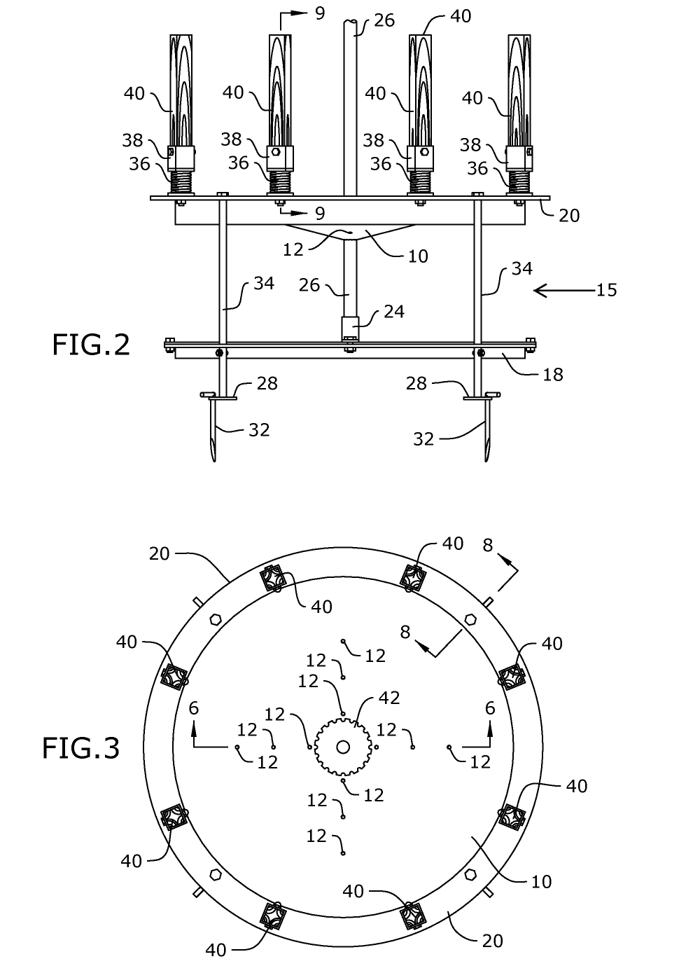

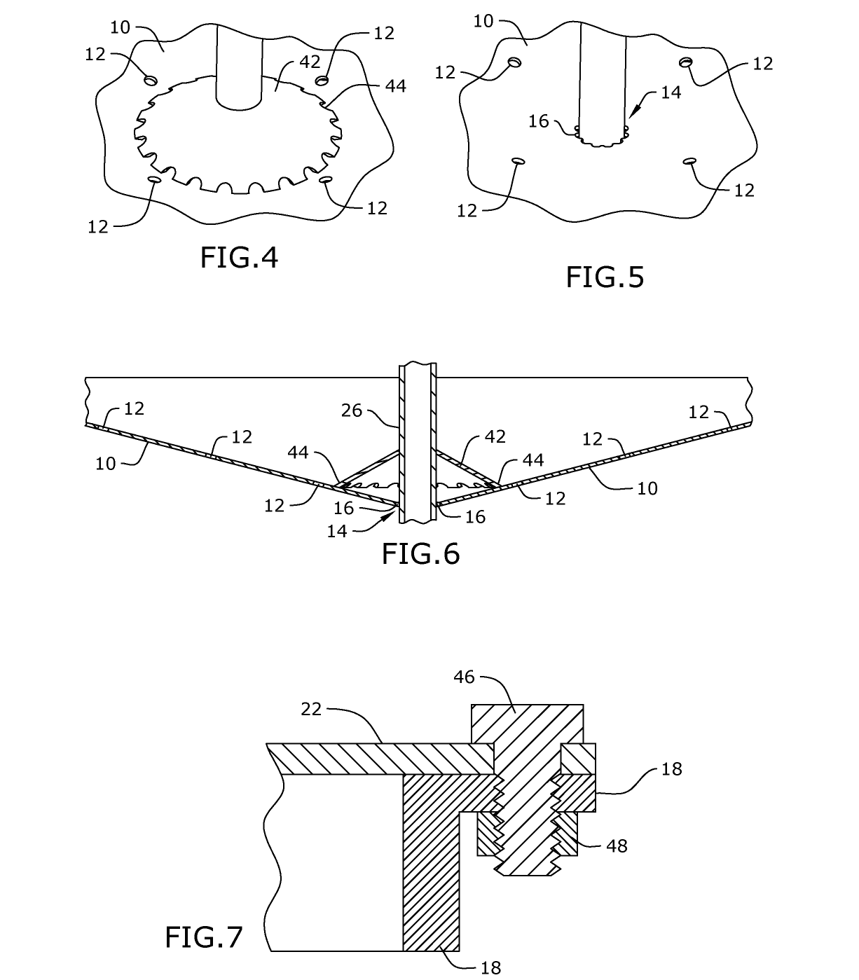

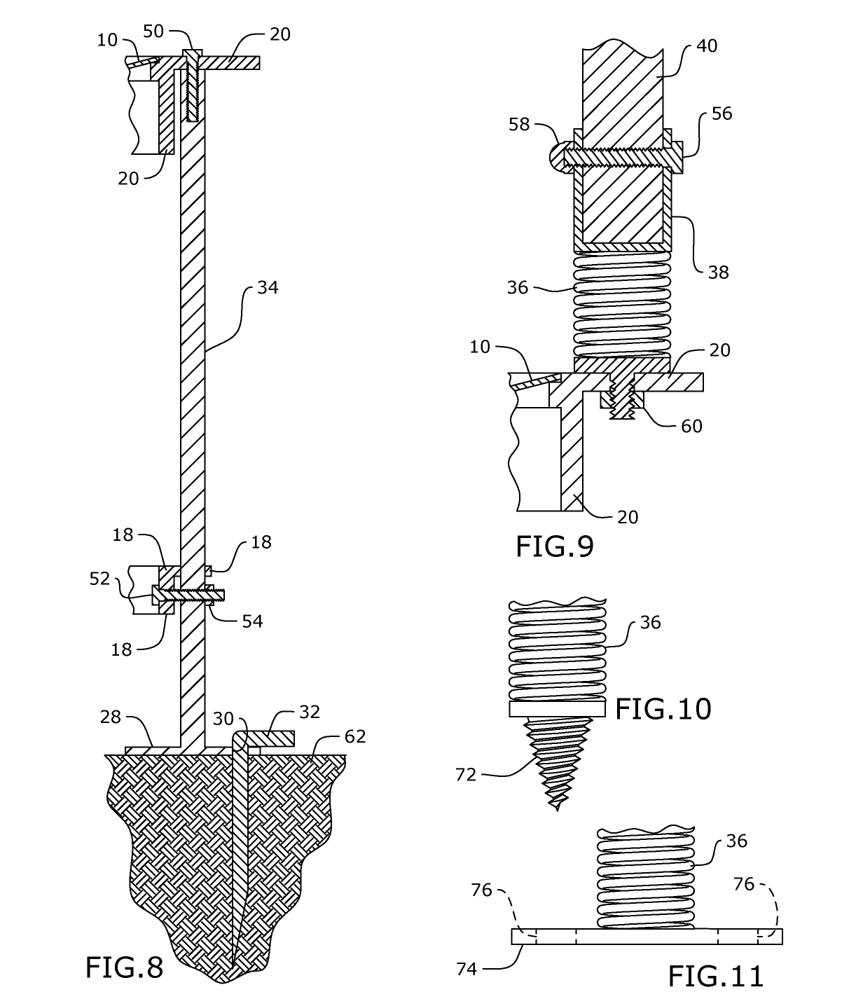

Referring to FIGS. 1 through 11, the present invention includes an antler shedding apparatus. The antler shedding apparatus includes a base frame 15, a feed tray 10 and a plurality of flexible uprights 36, 40. The base frame 15 supports the feed tray 10 in an upright elevated position. The feed tray 10 includes a feeding portion. Feed 64 is retained within the feeding portion. The plurality of flexible uprights 36, 40 are secured to the antler shedding apparatus and surround the feeding portion. The feed 64 attracts a deer 66 to the antler shedding apparatus. When the deer's head enters through the flexible uprights 36, 40, the antlers 68 may be removed from the pedicle 70 without harming the deer 66.

The base frame 15 of the present invention may include an upper frame member 20, a lower frame member 18 and a plurality of support poles 34. The support poles 34 may be vertically disposed. The lower frame member 18 may secured to the support poles 34 using fasteners 52 and nuts 54. The upper frame member 20 may secure to a top of the support poles 34 via a fastener 50. To add additional support, cross members 22 may be secured the lower frame member 18 by fasteners 46 and nuts 48. The feed tray 10 may be secured within the upper frame member 20, which elevates the feed tray 10 to a convenient height for a deer 66 to feed from. A plate foot 28 may be formed at a bottom end of each of the support poles 34. The plate foot 28 may be flat and substantially perpendicular to the support pole 34. The plate foot 28 may include an aperture 30 sized to receive a stake 32. Therefore, the base frame 15 may be secured to the ground 62 via the stakes 32. In certain embodiments, the upper frame member 20, the lower frame member 18 and the feed tray 12 are circular. The feed tray 12 may be circular allowing the deer 66 access to the feed 64 from all angles.

The feed tray 10 of the present invention may include an outer rim that tapers to a center portion 14, forming a hemispherical shape. The feed tray 10 may include a plurality of drainage apertures 12, and a plurality of center draining apertures 16 disposed near the center portion 14. The drainage apertures 12 may drain water from the feed tray 10. A feed pole 26 may be vertically disposed through the center portion 14. The feed pole 26 may be secured to the lower frame member 18 by a pole sleeve 24. The feed pole 26 is operable to distribute feed 64 to the feeding portion. A cover plate 42 may surround the feed pole 26 where the feed pole 26 meets the feed tray 10. The cover plate 42 may include drainage apertures 44 leading to the center drainage apertures 16.

The plurality of flexible uprights 36, 40 may include a spring 36 and a post 40. The post 40 may be made of a wood, a polymer, a metal or the like. The spring 36 biases the post in a vertical position. The present invention may include a post bracket 38. The post 40 may be secured within the post bracket 38 by a fastener 56 and a nut 58. The post bracket 38 is affixed to the spring 36, which is affixed to the antler shedding apparatus. In certain embodiments, the feed tray 10 includes an outer rim surrounding the feeding portion. The plurality of flexible uprights 36, 40 may be secured to the outer rim. Alternatively, the uprights 36, 40 may be secured directly to a top surface of the upper frame member 20. The flexible uprights 36, 40 may be secured to the antler shedding apparatus in a circular formation.

The uprights 36, 40 may be secured to the antler shedding apparatus by a threaded bracket and a nut 60. Alternatively, the spring 36 may be directly connected to a mounting screw 72 that threadably secures with a female threaded portion of the antler shedding apparatus. Further, in certain embodiments, the spring 36 may be secured to a mounting bracket 74 having mounting plate holes 76. Fasteners may run through the mounting plate holes 76 and into the upper frame member 20.

It should be understood, of course, that the foregoing relates to exemplary embodiments of the invention and that modifications may be made without departing from the spirit and scope of the invention as set forth in the following claims.

What is claimed is:

1. An antler shedding apparatus comprising:
a feed tray comprising a feeding portion operable to retain a feed; and
a plurality flexible uprights disposed about the feeding portion, wherein each of the plurality of flexible uprights comprises a spring secured to a post.

2. The antler shedding apparatus of claim 1, wherein the spring biases the post in a vertical position.

3. The antler shedding apparatus of claim 1, wherein the feed tray comprises an outer rim surrounding the feeding portion, wherein the plurality of flexible uprights are secured to the outer rim.

4. The antler shedding apparatus of claim 1, wherein the feeding portion tapers to a center portion.

5. The antler shedding apparatus of claim 4, wherein the feeding portion comprises a hemispherical shape.

6. The antler shedding apparatus of claim 4, further comprising a feed pole vertically disposed through the center portion, wherein the feed pole is operable to distribute feed to the feeding portion.

7. The antler shedding apparatus of claim 1, wherein the feeding portion comprises a plurality of drainage apertures.

8. The antler shedding apparatus of claim 1, further comprising a base frame supporting the feed tray in an upright position.

9. The antler shedding apparatus of claim 8, wherein the base frame comprises a plurality of support poles each comprising a top end and a bottom end, wherein the top end is secured to the feed tray and the bottom end comprises a plate foot substantially perpendicular to the support pole.

10. The antler shedding apparatus of claim 9, wherein the plate foot comprises an aperture sized to receive a stake.

11. The antler shedding apparatus of claim 8, wherein the base frame comprises:
an upper frame member;
a lower frame member;
a plurality of cross members secured to the lower frame member; and
a plurality of support poles securing the upper frame member and the lower frame member together,
wherein the feed tray is secured within the upper frame member, and the plurality of flexible uprights are secured to an upper surface of the upper frame member.

12. The antler shedding apparatus of claim 11, wherein the upper frame member, the lower frame member and the feed tray are circular.
